(19) United States
(12) Patent Application Publication
(10) Pub. No.: US 2026/0144232 A1
(43) Pub. Date: May 28, 2026

(54) Equine Support Boot with Angled Lower Strap

(71) Applicant: Western Legacy Sales, LLC, Alvarado, TX (US)

(72) Inventor: Ward Heid, Alvarado, TX (US)

(73) Assignee: Western Legacy Sales, LLC, Alvarado, TX (US)

(21) Appl. No.: 18/959,873

(22) Filed: Nov. 26, 2024

(51) Int. Cl. A01K 13/00

(52) U.S. Cl. CPC A01K 13/007

(57) ABSTRACT

A equine support boot includes a base portion configured to wrap around the fetlock joint of a horse, at least one upper fabric strap connected to the base portion, at least one upper strap, a primary sling strap, and a secondary sling strap for tightening the base portion to the leg of a horse. The base portion further includes an internal padded layer, an exterior loop-type fabric layer, and a concave portion for receiving the fetlock joint. The at least one upper strap extends outwardly from the base portion to secure the base portion onto the leg of the horse. The first sling strap extends outwardly from the base portion and the second sling strap extends outwardly from the first sling strap.

### BACKGROUND

### 1. Field of the Invention

The present invention relates to equine support boots. In particular, the present invention relates to support boots for the lower limbs of horses.

### 2. Description of Related Art

For centuries, the bond between man and horse has been a strong one. At times in history, the survival of people would not have been possible without horses. Today, although most people are no longer dependent upon horses, the livelihoods of many people are still dependent upon access to strong, healthy horses. Indeed, the equine industry has never been stronger. Every day, around the world, thousands of horses are bought, sold, and traded for a wide variety of uses. Some are race horses, some are show horses, and some simply work day in and day out on farms and ranches throughout the world. Regardless of how they are used, horses must be cared for and maintained if they are to continue to be healthy, strong, and valuable.

Each year, vast sums are money are spent on the health and maintenance of horses. Hundreds of millions of dollars are spent on tools, tack, equipment, gear, supplies, accessories, training, and veterinary services to ensure that horses remain healthy and fit. Not only are horses treated after they have become injured, but significant resources are expended to prevent injuries from ever occurring. In recent years, the emphasis on prevention of injuries to horses has increased dramatically. Significant strides have been made in the areas of medicine, education, training, and equipment to help reduce the types and numbers of injuries sustained by horses.

One area of the equine industry that has seen tremendous growth is protective wear for horses'legs. These days, a myriad of products are available to protect a horse's legs from injury, including many different types of ankle boots, skid boots, splint boots, knee boots, support boots, and leg wraps. These products often offer new designs and incorporate new materials. Unfortunately, some of these products perform their advertised and intended purposes, and some do not. For example, some boots are advertised as support boots, but provide little or no support whatsoever.

Thus, although the foregoing products and methods represent great strides in the area of equine support boots, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1A is a perspective view of the equine support boot with an angled lower strap according to the present application;

FIG. 1B is a front view of the equine support boot with an angled lower strap of FIG. 1A;

FIG. 1C is a back view of the equine support boot with an angled lower strap of FIG. 1A;

FIG. 2 is a rear view of the equine support boot with an angled lower strap of FIG. 1A installed onto the lower leg of a horse;

FIG. 3 is a front view of the equine support boot with an angled lower strap of FIG. 1A installed onto the lower leg of a horse;

FIG. 4 is a left side view of the equine support boot with an angled lower strap of FIG. 1A installed onto the lower leg of a horse;

FIG. 5 is a longitudinal cross-sectional view of the equine support boot with an angled lower strap of FIG. 1A taken at cross-section line A-A of FIG. 2 with a portion of the horse's lower leg included to illustrate the general alignment of the support boot;

FIG. 6A is a perspective view of the equine support boot with an angled lower strap according to an alternative embodiment of the present application;

FIG. 6B is a front view of the equine support boot with an angled lower strap of FIG. 6A;

FIG. 6C is a back view of the equine support boot with an angled lower strap of FIG. 6A;

FIG. 7 is a rear view of the equine support boot with an angled lower strap of FIG. 6A installed onto the lower leg of a horse;

FIG. 8 is a front view of the equine support boot with an angled lower strap of FIG. 6A installed onto the lower leg of a horse;

FIG. 9 is a left side view of the equine support boot with an angled lower strap of FIG. 6A installed onto the lower leg of a horse;

FIG. 10 is a longitudinal cross-sectional view of the equine support boot with an angled lower strap of FIG. 6A taken at cross-section line B-B of FIG. 7 with a portion of the horse's lower leg included to illustrate the general alignment of the support boot; and

FIG. 11 is a perspective view of the equine support boot with an angled lower strap according to an alternative embodiment of the present application.

While the assembly and method of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the Equine Support Boot with Angled Lower Strap according to the present application are provided below. It will of course be appreciated that in the development of any actual embodiment, numerous implementation-specific decisions will be made to achieve the developer's specific goals, such as compliance with assembly-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. It is also appreciated that the use of “a” or “an” before a noun naming an object is construed to be that the noun refers to both the singular and the plural.

The equine support boot of the present disclosure provides support to the fetlock joint and the bones, tendons, and ligaments, and other structures associated with the fetlock joint of a horse's leg. The support boot restricts and selectively controls the movement of the fetlock joint and may be used as an injury prevention device and/or as a therapeutic device for horses that have already been injured. For horses that have already been injured, the support boot provides stability in the rehabilitation process, which allows the horse to react better to treatment. Use of the support boot during rehabilitation of a lame horse can reduce the overall time required to rehabilitate the horse.

The support boot may be utilized in a wide variety of configurations. Although the support boot is described herein with respect to an orthopedic device, the support boot may have different configurations. For example, in some instances the support boot may be configured for use as a skid boot to add cushioning between a horse's fetlock joint and the ground. In other implementations, the support boot may be configured as a splint boot to add support, cushioning, and protection from crossover injuries.

When applied, the support boot may extend from the proximal cannon bone to the distal pastern. The support boot may cover and protect areas proximal to the fetlock joint along with providing support to the flexor tendons and suspensory ligament by decreasing the palmar/plantar movement, i.e., “bowing,” of these structures during load-bearing. The area of coverage and the materials used in the construction of the support boot and its component parts may also provide protection from blunt force injuries, such as over-reach, interference, run-down injuries, as well as others.

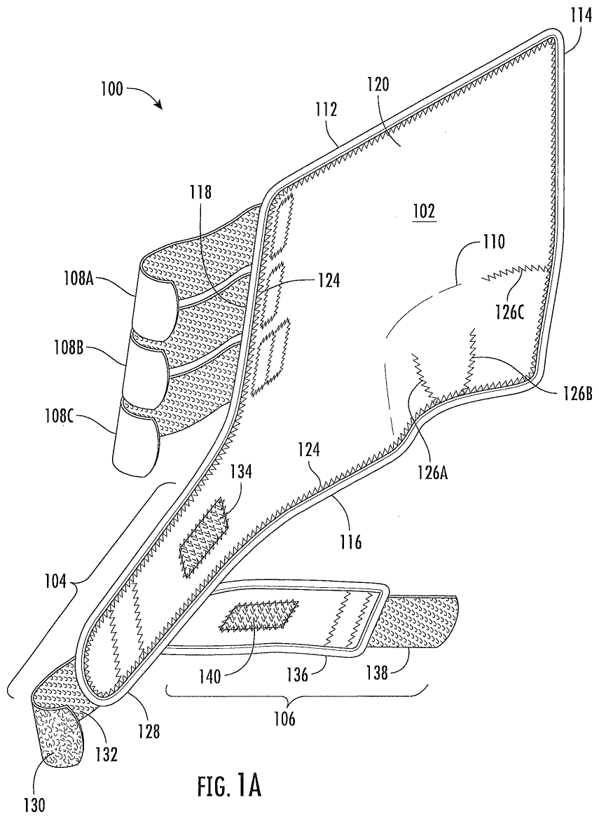

Referring now to FIG. 1A-1C in the drawings, various views of equine support boot with angled lower strap 100 according to the preferred embodiment are depicted. As shown in FIG. 1A, support boot 100 is comprised of base portion 102, primary sling strap 104, secondary sling strap 106, upper straps 108a-108c, concave portion 110, top edge 112, rear edge 114, bottom edge 116, front edge 118, inner neoprene layer 120, exterior hook-loop fabric layer 122, stitching 124, pleats 126a-126c, primary tab portion 128, receiver 130, primary connector 132, primary interior connector 134, secondary tab portion 136, secondary connector 138, and secondary interior connector 140. Base portion 102 is typically formed from one or more layers of compliant materials. For example, in the preferred embodiment, base portion 102 is formed from inner neoprene layer 120 that is bonded to an exterior surface of exterior hook-loop fabric layer 122 which may be formed from or include a length of unbroken hook or loop fabric. In the present embodiment, exterior hook-loop fabric layer 122 is formed from loop fabric to function as the loop portion of a hook and loop type bond between primary sling strap 104 and base portion 102, between secondary sling strap 106 and base portion 102, and upper straps 108a-108c and base portion 102. While exterior hook-loop fabric layer 122 is formed from loop fabric in the present application, alternative embodiments also exist where exterior hook-loop fabric layer is instead constructed from hook fabric or a combination of hook and loop fabric. Alternative embodiments may also exist where a thin knit fabric may be secured to the interior surface of neoprene layer 120 to protect and enhance the performance of neoprene layer 120.

Base portion 102 of support boot 100 may further be formed from one or more additional layers of compliant materials. For example, open cell or closed cell foam materials may be used. Additional examples of types of materials that may be used in base portion 102 are: blend materials containing various polymers used in the manufacture of cellular rubber materials that are bonded together; anti-static flexible polyurethane foam; bonded foam from foam crumbs or shredded flexible polyurethane foam that has been rebonded; densified foam, rubber, inorganic materials; latex foam; molded foam; neoprene; polyester; polyether; polymeric foam; polypropylene; polymers; reticulated foam; and silicone (rubber and foam), to name a few. It is understood that other examples are prevalent in the art and may be used to produce a compliant material suitable for support boot 100.

Alternative embodiments also exist where support boot 100 has a series of perforations in base portion 102. In embodiments containing perforations, the perforations are configured to selectively increase compliance and the breathability of support boot 100. An animal that is injured often undergoes selected treatment regimens that focus on specific amounts of rest and exercise to enable a full recovery. Often it is unlikely that an animal remains immobilized during the recovery process. Moisture can get introduced to the boot from the environment or be introduced into the boot from sweat during rehabilitation. Moisture that is not permitted to escape can cause irritation between the boot and the animal's skin and/or injury. As such, perforations allow for moisture to escape the interior of support boot 100 to avoid a buildup of moisture within during rehabilitation.

In the preferred embodiment, one or more portions of support boot 100 may be connected with stitching 124. For example, in some instances, stitching 124 may be utilized along top edge 112, rear edge 114, bottom edge 116, and front edge 118 to together neoprene layer 120, the thin knit fabric, and exterior hook-loop fabric layer 122 and prevent delaminating. Upper straps 108a-108c may also be connected to support boot 100 using stitching 124. Upper straps 108a-108c extend outwardly from front edge 118 allowing for straps 108a-108c to extend over and attach to base portion 102 when base portion 102 is wrapped around a horse's leg to secure support boot 100 to the horse's leg. Upper straps 108a-108c are formed from hook-loop fabric and in the preferred embodiment, straps 108a-108c are formed from hook fabric to function as the hook portion of a hook and loop type bond between straps 108a-108c and exterior hook-loop fabric layer 122 on the back of base portion 102. While hook fabric is used for upper straps 108a-108c in the preferred embodiment, alternative embodiments also exist where straps 108a-108c are constructed from loop fabric or a combination of the two in order to couple onto exterior hook-loop fabric layer 122. The hook-loop fabric used in upper straps 108a-108c may be standard nonelastic hook-loop fabric, or the hook-loop fabric can be an elastic hook-loop fabric that is able to stretch beyond the reach of standard hook-loop fabric. In the current application, only upper strap 108c is formed from the elastic hook-loop fabric, and as such, upper strap 108c requires extra stitching 124 to secure strap 108c to base portion 102 to prevent strap 108c from being removed when stretched. However, alternative embodiments may also exist where all upper straps 108a-108c are formed from elastic fabric or where a certain arrangement of upper straps 108a-108c, such as upper strap 108a and 108c, are formed from the elastic fabric. The elastic hook-loop material allows upper straps 108a-108c to extend further across base portion 102 to create a tighter fit around a horse's leg.

Formed in or adjacent to bottom edge 116 is concave portion 110 where the back of the fetlock joint rests when support boot 100 is secured to a horse. Concave portion 110 is shaped by at least one set of pleats, such as pleats 126a-126c, formed within base portion 102. Pleats 126a and 126b extend vertically up from bottom edge 116 while pleat 126c extends horizontally from rear edge 114 to form concave portion 110. Pleats 126a and 126b form a groove to receive the back of a horse's leg while pleat 126c extends the area of concave portion 110 to rear edge 114 increasing the room within concave portion 110. Concave portion 110 is sized to form around the sides of a horse's leg while supporting the back of the fetlock joint.

The exterior surface of base portion 102 at concave portion 110 may optionally be coated, treated, or overlaid with a tough, durable material to prevent damage to base portion 102. For example, materials such as nylon, Kevlar, rubber, plastic, or other suitable materials may be applied to base portion 102 at concave portion 110 for this purpose. The application of such materials may be particularly useful in instances in which support boot 100 is adapted for use as a skid boot. It will be appreciated that such treatment or addition to concave portion 110 may be integral with concave portion 110, may be bonded to concave portion 110, or may be releasably coupled to concave portion 110.

Alternative embodiments of support boot 100 also exist where base portion 102 includes one or more optional tendon support members. In some implementations, the tendon support members may be semi-rigid, compliant structures that extend inwardly from base portion 102 and are configured and arranged to engage the tendon grooves of the horse's lower leg. When support boot 100 is applied to the lower leg of a horse, the tendon support members provide lateral support and stabilization to the flexor tendons, the suspensory ligament, the sesamoidean ligaments, the sesamoid bones, and other tendons, ligaments, and bones in the area of the fetlock joint and lower pastern. In addition, the tendon support members ensure that support boot 100 is properly aligned during application to the horse's lower leg, along with preventing rotation of support boot 100 about the horse's leg during operation.

The tendon support members may be implemented in a wide variety of materials, shapes, and sizes. For example, the tendon support members may be integral with and formed of the same material as base portion 102. Alternately, the tendon support members may be formed of a different material, such as nylon, leather, rubber, plastic, or other suitable material. Further, the tendon support members may be coated or treated with other compliant materials. In instances in which the tendon support members are formed from alternative materials, the tendon support members may be bonded to base portion 102 or secured into slots, pouches, or pockets in base portion 102. In other implementations, the tendon support members may be removably placed into slots, pouches, or pockets, permitting the selective use of the tendon support members on a case-by-case basis. The tendon support members may be formed as elongated ribs, circular buttons, oval ridges, and/or other shapes, either alone or in combination with each other. In addition, the tendon support members may have custom configurations of shapes and materials that are selectively tailored for particular maladies, applications, or individual horses.

Alternative embodiments also exist where support boot 100 includes a splint pad which allows support boot 100 to also function as a splint boot. In some instances, the splint pad may be formed from an additional layer or layers of padding in a generally upright configuration. Further, if support boot 100 has tendon support members, the splint pad may be wider than the tendon support members and provide support, cushioning, and protection from crossover injuries. A support boot 100 that includes the splint pad may or may not include secondary sling strap 106.

As shown in FIGS. 1B and 1C, primary sling strap 104 extends at a downward angle a, typically 25-45 degrees, from base portion 102 and is comprised of primary tab portion 128, receiver 130, primary connector 132, and primary interior connector 134. While a is typically a 25-45 degree angle, alternative embodiments may also exist where a is more than or less than 25-45 degrees so long as primary sling strap 104 is angled at a downward angle. Primary tab portion 128 is an elongated section of material extending outwardly from base portion 102 at a downward angle away from the corner formed by the intersection of bottom edge 116 and front edge 118. The downward angle of primary sling strap 104 allows for primary strap 104 to be pulled up and secured to base portion 102 at an orientation that prevents the fabric of base portion 102 from bunching together when support boot 100 is attached to a horse's leg. When primary sling strap 104 extends directly from base portion 102 at the corner of front edge 118 and bottom edge 116, the material of base portion 102 at bottom edge 116 bunches up when primary sling strap 104 is pulled up to couple with base portion 102. When the material of base portion 102 bunches in this manner, the material may abrasively contact the horse's leg and potentially further injure the horse or delay the healing process. By angling primary sling strap 104 at a downward orientation at the corner of front edge 118 and bottom edge 116, bottom edge 116 will no longer bunch up when strap 104 is pulled up to connect to base portion 102. Alternative embodiments may also exist where primary sling strap 104 can be angled at an upward angle relative to base portion 102. When coupling primary sling strap 104 to base portion 102, strap 104 is pulled underneath concave portion 110 before being coupled to base portion 102 to help support the fetlock joint. If primary sling strap 104 did not extend at angle a from base portion 102, wrapping strap 104 along concave portion 110 would warp bottom edge 116 causing the material to bunch up.

Connected to the end of primary tab portion 128 not connected to base portion 102 is primary connector 132 which extends the reach of first sling strap 104. In the present application, primary connector 132 is attached to primary tab portion 128 with stitches 124, however, alternative embodiments also exist where primary connector 132 and primary tab portion 128 are made from the same section of material. Primary connector 132 is formed from hook-loop fabric and in the preferred embodiment, connector 132 is particularly formed from hook fabric to function as the hook portion of a hook and loop type bond between primary sling strap 104 and base portion 102. While primary connector 132 is preferably constructed from hook fabric, alternative embodiments also exist where connector 132 is instead formed from loop fabric or a combination of the two so as to connect to base portion 102. The hook-loop fabric used in primary connector 132 can be the standard hook-loop fabric or the fabric can be the elastic hook-loop fabric used in upper straps 108a-108c extending the reach of primary connector 132. Stitched to the side of primary connector 132 that is not covered in hook-loop fabric is receiver 130 which is also formed from a hook-loop fabric, in the preferred embodiment, receiver 130 is constructed from loop fabric to function as the loop portion of a hook and loop type bond between primary sling strap 104 and secondary sling strap 106. However, alternative embodiments also exist where receiver 130 is instead formed from hook fabric or a combination of hook and loop fabric so as to couple to secondary sling strap 106. Receiver 130 may be stitched or otherwise attached to the exterior surface of primary connector 132 and may also extend over onto a portion of the exterior surface of primary tab portion 128. Some embodiments of support boot 100 further have primary interior connector 134 stitched or otherwise attached to the interior surface of primary tab portion 128. Primary interior connector 134 is formed from a loop-hook type fabric and in the preferred embodiment, connector 134 is particularly formed from hook fabric to function as the hook portion of a hook and loop type bond between primary sling strap 104 and base portion 102 to help maintain the shape of support boot 100 when attached to a horse's leg. However, alternative embodiments exist where primary interior connector 134 is constructed from loop fabric or a combination of hook and loop type fabric to connect to base portion 102. Alternative embodiments also exist where support boot 100 does not have primary interior connector 134 and instead the interior surface of primary tab portion 128 is smooth.

Attached to the exterior surface of primary tab portion 128 is secondary sling strap 106 which is comprised of secondary tab portion 136, secondary connector 138, and secondary interior connector 140. Secondary tab portion 136 is formed from the same material as base portion 102 and is attached to the exterior surface of primary tab portion 128 of primary sling strap 104 by stitching 124 as seen in FIG. 1C. Alternative embodiments also exist where secondary tab portion 136 is formed from a material different than base portion 102 or where secondary sling strap 106 is connected to the surface of base portion 102 instead of primary tab portion 128. Alternative embodiments may also exist where secondary sling strap 106 and primary sling strap 104 are constructed from the same length of material. Attached to the end of secondary tab portion 136 not connected to primary tab portion 128 is secondary connector 138 which extends the reach of secondary tab portion 136. While secondary connector 138 is shown to be connected to secondary tab portion 136 by stitching 124, alternative embodiments also exist where secondary connector 138 and secondary tab portion 136 are made from the same section of material. Secondary connector 138 is formed from hook-loop fabric and in the preferred embodiment, connector 138 is preferably formed from hook fabric to function as the hook portion of a hook and loop type bond between secondary sling strap 106 and primary sling strap 104. However, alternative embodiments also exist where secondary connector 138 is instead formed from loop fabric or a combination of hook and loop fabric so as secondary connector 138 is capable of coupling onto primary sling strap 104. The hook-loop fabric forming secondary connector 138 may be standard hook-loop fabric or the elastic hook-loop fabric described above extending the reach of secondary connector 138. Some embodiments of support boot 100 further have secondary interior connector 140 stitched or otherwise bonded to the interior surface of secondary tab portion 136. Secondary interior connector 140 is formed from hook-loop fabric and in the preferred embodiment, connector 140 is formed from hook type fabric to function as the hook portion of a hook and loop type bond between secondary sling strap 106 and the exterior surface of primary tab portion 128. However, alternative embodiments also exist where secondary interior connector 140 may be constructed from loop fabric or a combination of both hook and loop fabric so that connector 140 can couple onto primary tab portion 128. In instances where both primary interior connector 134 and secondary interior connector 140 are on support boot 100, primary interior connector 134 and secondary interior connector 140 may be aligned during installation of the support boot 100 onto the horse's leg to improve the overall stability.

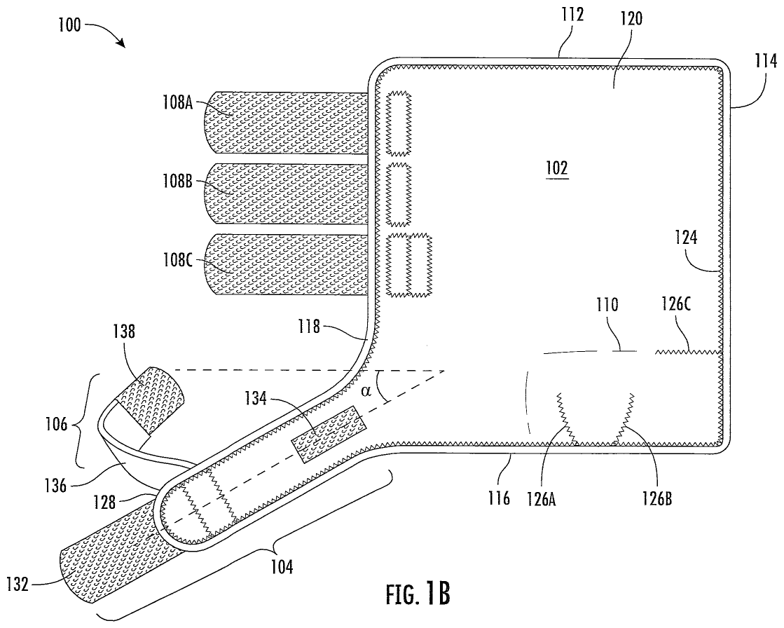

Referring now also to FIGS. 2-4 in the drawings, various views of support boot 100 installed around the fetlock joint and lower leg of a horse are depicted. As shown, support boot 100 extends from the proximal cannon bone to the distal pastern. According to some implementations, many of the components of support boot 100 may be constructed from compliant materials that, when stretched and applied to a horse's lower leg, provide support boot 100 with a strong and rigid support structure. This feature allows support boot 100 to cover and protect the areas proximal to the horse's fetlock joint, and provides support to the flexor tendons and suspensory ligament by decreasing the palmar/plantar movement, i.e., “bowing,” of these structures during load-bearing. In addition, because support boot 100 may be formed, at least in part, from generally padded, compliant materials, the configuration and construction of support boot 100 can provide protection from blunt force injuries, such as over-reach, interference, run-down injuries, and others.

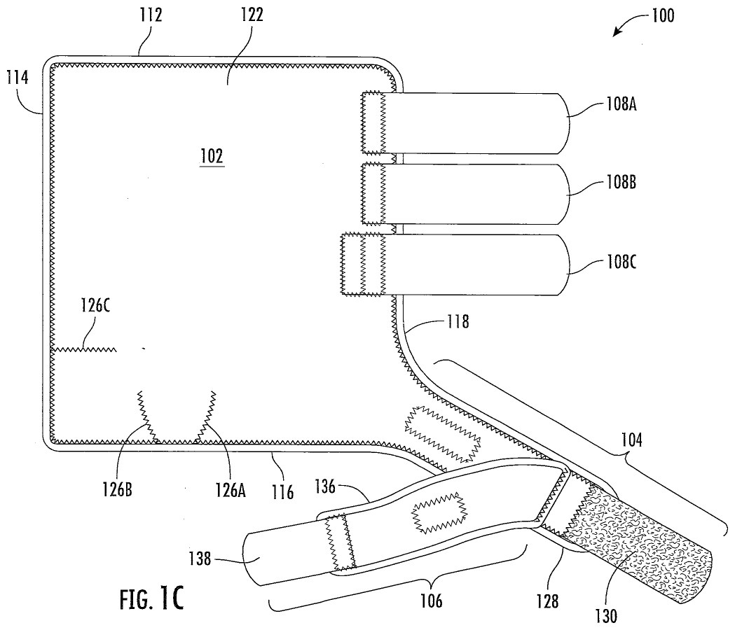

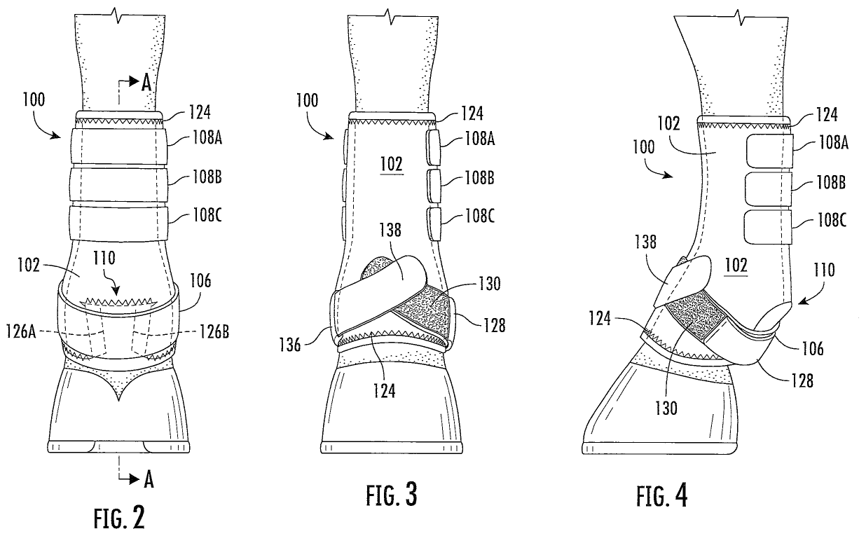

In FIGS. 3 and 4, an attachment configuration of primary sling strap 104 and secondary sling strap 106 are depicted. The dual sling-strap configuration provides an upward force against a fetlock joint when straps 104 and 106 are used to tighten support boot 100 onto a horse's leg. When primary sling strap 104 and secondary sling strap 106 extend around support boot 100, straps 104 and 106 are pulled below the concave portion 110 as shown in FIG. 4 before being pulled up against concave portion 110 and secured to base portion 102. The upward forces provided by the dual sling-strap are considerable as this configuration provides additional resistance to extension of the fetlock joint while also providing consistent pressure against the joint to facilitate rehabilitation. This additional resistance supports the fetlock joint within support boot 100 while also preventing extra force from being applied to the joint which could cause complications during recovery. FIG. 4 shows how straps 104 and 106 are pulled upwards and perpendicularly cross over each other across base portion 102 to continuously apply the upward pressure to concave portion 110. As stated earlier, if a primary sling strap 104 was used that was not angled down such as in the present embodiment, bottom edge 116 would bunch up against the horse's leg as strap 104 is pulled up under concave portion 110 as shown in FIG. 4. The angled nature of primary sling strap 104 prevents the bunching of material as the angle that strap 104 is designed to have matches the ideal angle of pulling strap 104 under concave portion 110 to support the fetlock joint.

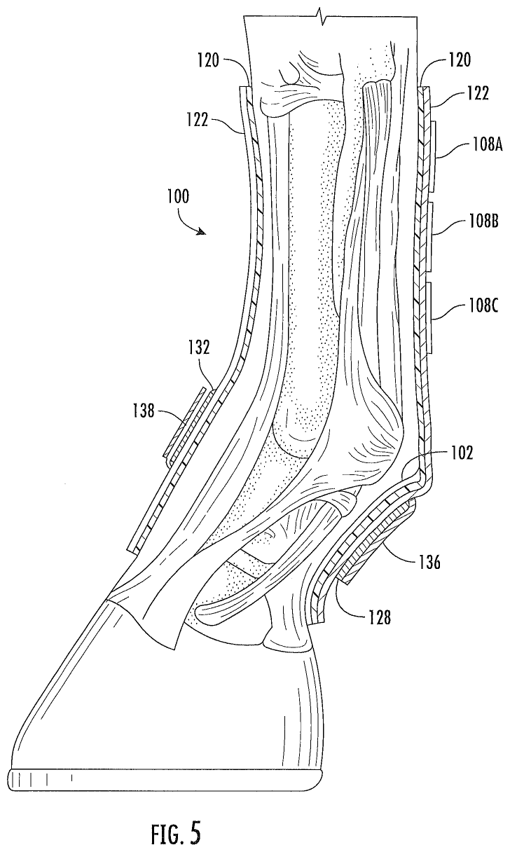

Referring now to FIG. 5 in the drawings, a longitudinal cross-sectional view of support boot 100 is depicted. This cross-sectional view is taken along cross section line A-A of FIG. 2 with a portion of the horse's lower leg included to illustrate the general alignment of support boot 100. FIG. 5 provides a view into the horse's leg to display how support boot 100 supports the horse's leg when used. As seen in FIG. 5, the tendons and muscles at the fetlock joint are aligned with concave portion 110 and are supported by primary sling strap 104 and secondary sling strap 106 when attached.

To secure support boot 100 onto a horse's leg, concave portion 110 is first positioned just beneath the fetlock joint of the horse's leg so as to fully receive the fetlock joint. Base portion 102 is then wrapped snuggly around the horse's leg and secured in place by stretching and attaching upper straps 108a-108c to exterior hook-loop fabric layer 120. In this step, it is preferred that top edge 112 be aligned around the horse's leg as base portion 102 is secured. In addition, in those embodiments in which tendon support members are employed, base portion 102 is arranged such that the tendon support members engage the tendon grooves of the horse's lower leg to help with alignment. Once base portion 102 has been wrapped around the horse's leg, primary sling strap 104 is pulled down underneath concave portion 110 before being pulled back up and secured to the front of base portion 102. Once primary sling strap 104 is secured to base portion 102, secondary sling strap 106 is then pulled across base portion 102 as well and crossed against primary sling strap 104 to tighten support boot 100 onto the horse's leg. As both primary sling strap 104 and secondary sling strap 106 are used to support concave portion 110, both straps 104 and 106 are pulled up over base portion 102 at an angle leading to secondary strap 106 perpendicularly cross over primary strap 104 in an X formation allowing for secondary strap 106 to be secured to both primary strap 104 and base portion 102 for extra stability while also maintaining the upward pressure against concave portion 110. In the embodiments in which primary interior connector 134 and secondary interior connector 140 are used, it is preferred that primary interior connector 134 be aligned with secondary interior connector 140. The cross-over attachment and multiple connection points of primary sling strap 104, secondary sling strap 106, and upper straps 108a-108c, which are best seen in FIGS. 2 and 3, provide a secure attachment of support boot 100 to a horse's leg.

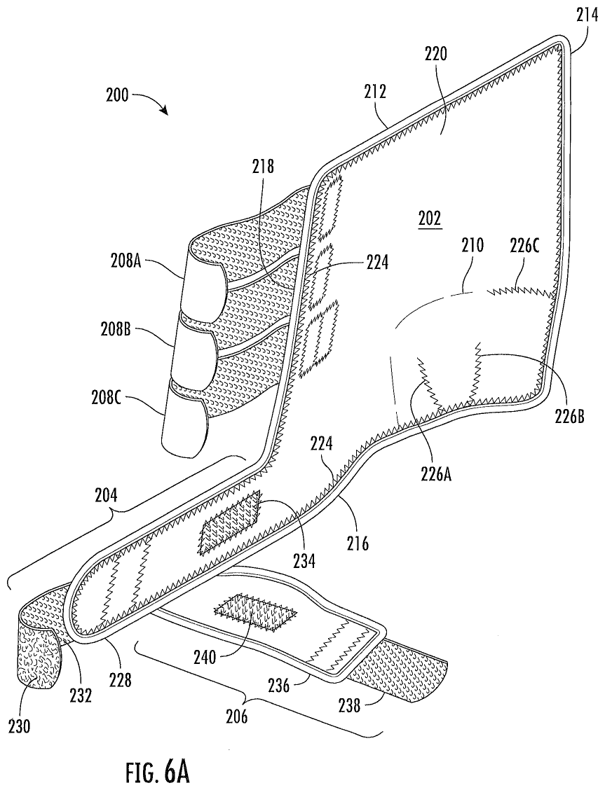

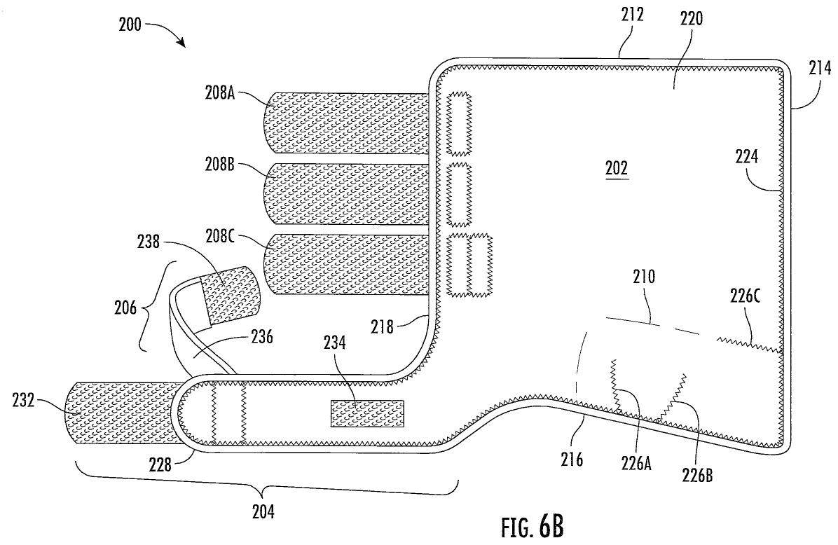

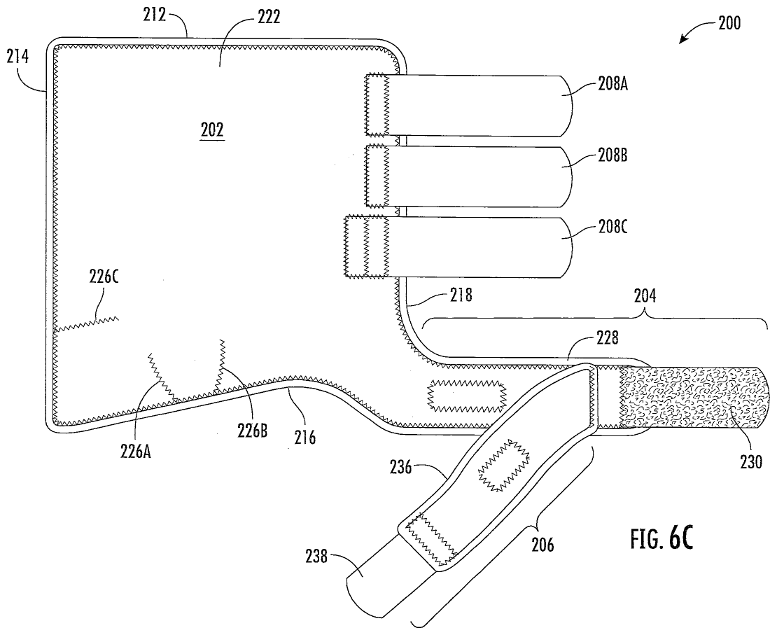

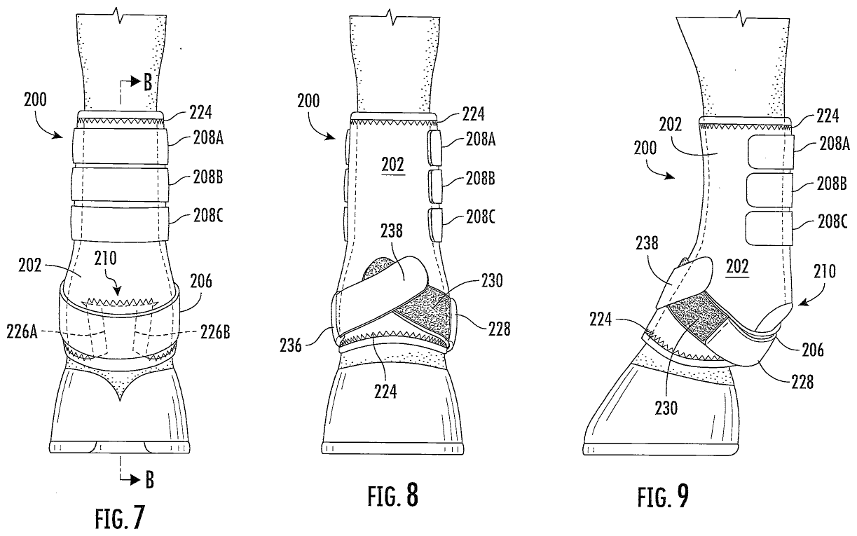

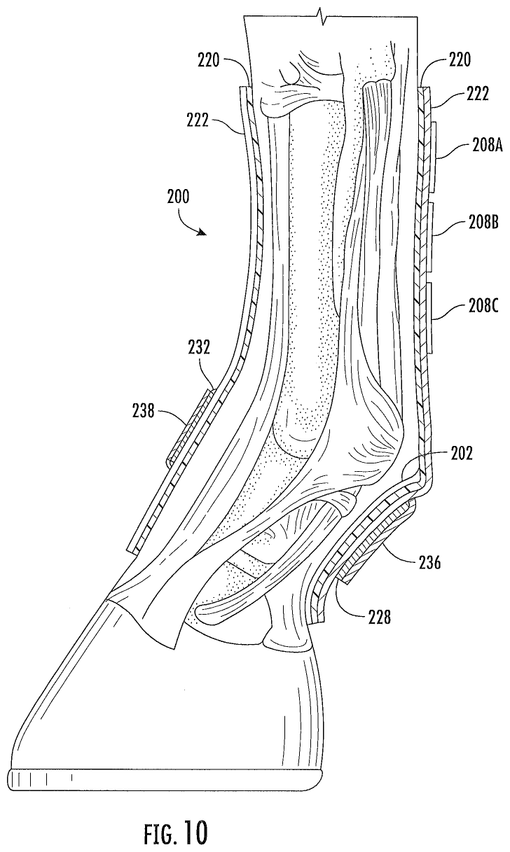

Referring now to FIGS. 6A-10 in the drawings, various views of support boot 200 according to an alternative embodiment are depicted. Alternative support boot 200 is comprised of base portion 202, primary sling strap 204, secondary sling strap 206, upper straps 208a-208c, concave portion 210, top edge 212, rear edge 214, arched bottom edge 216, front edge 218, inner neoprene layer 220, exterior hook-loop fabric layer 222, stitching 224, pleats 226a-226c, primary tab portion 228, receiver 230, primary connector 232, primary interior connector 234, secondary tab portion 236, secondary connector 238, and secondary interior connector 240. Support boot 200 has the same functionality as support boot 100 of the preferred embodiment, however, support boot 200 has an arched bottom edge 216 instead of a straight bottom edge 116. Further, primary sling strap 204 of support boot 200 is not positioned at a downward angle and instead extends directly outward from support boot 200 at the corner formed by bottom edge 216 and front edge 218 unlike primary sling strap 104 of support boot 100. While it was previously described that a non-angled primary sling strap 204 would cause the material base portion 202 to bunch up when secured to a horse's leg, arched bottom edge 216 works to prevent the material from bunching even without an angled strap 204. The curved edge of arched bottom edge 216 is designed so that when primary sling strap 204 is pulled up, the arch will be pulled and pressed against the horse's leg instead of bunching up. The material removed to form arched bottom edge 216 was typically the material that would bunch up when primary sling strap 204 would be pulled up is strap 204 was not angled downward. As such, when primary sling strap 204 is pulled up, the curve of arched bottom edge 216 forms around the fetlock joint of a horse's leg preventing the material from bunching at the bottom. Thus, arched bottom edge 216 provides an alternative way of preventing the bunching of material when support boot 200 is in use.

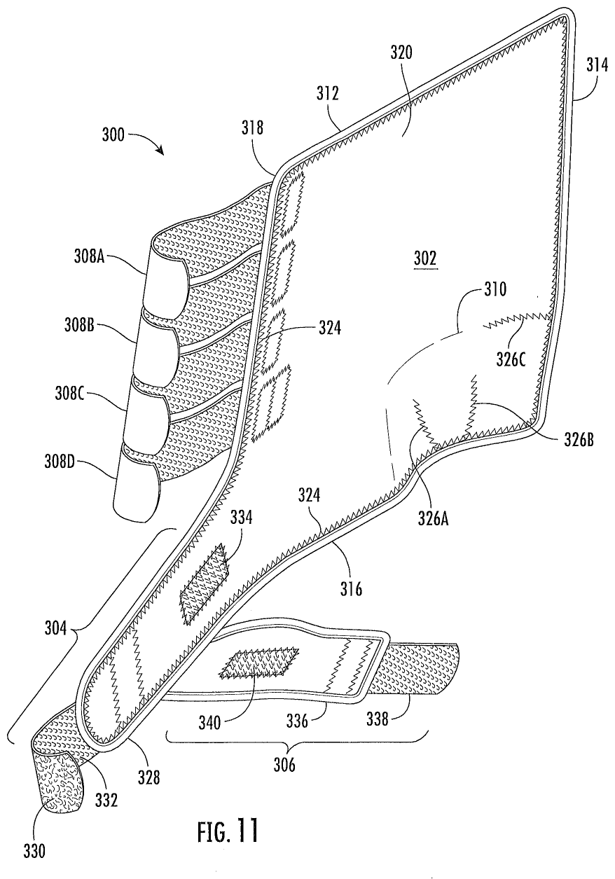

Referring now to FIG. 11 in the drawings, a perspective view of support boot 300 according to an alternative embodiment is depicted. Alternative support boot 300 is comprised of base portion 302, primary sling strap 304, secondary sling strap 306, upper straps 308a-308d, concave portion 310, top edge 312, rear edge 314, arched bottom edge 316, front edge 318, inner neoprene layer 320, exterior hook-loop fabric layer 322, stitching 324, pleats 326a-226c, primary tab portion 328, receiver 330, primary connector 332, primary interior connector 334, secondary tab portion 336, secondary connector 338, and secondary interior connector 340. Support boot 300 has the same functionality as support boot 100 of the preferred embodiment, however, support boot 300 has an additional upper strap 308d. While three upper straps 108a-108c are shown in the preferred embodiment, as shown in FIG. 11 with upper straps 308a-308d, there may be more than three or less than three upper straps 308 to help secure support boot 300 onto a horse's leg.

It is apparent that a system with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description and claims. Although the present embodiments are shown above, they are not limited to just these embodiments, but are amenable to various changes and modifications without departing from the spirit thereof.

1. An equine support boot for supporting a fetlock joint of a horse, comprising:
a base portion, comprising:
at least one internal padded layer;
an exterior hook-loop fabric layer; and
a concave portion selectively sized for receiving the fetlock joint;
at least one upper strap extending outwardly from the base portion, the at least one upper strap being constructed from hook-loop fabric, such that the at least one upper strap is releasably couplable to the exterior hook-loop fabric layer;
a primary sling strap extending outwardly from the base portion at an angle, the primary sling strap adjustably securing the base portion around the fetlock joint; and
a secondary sling strap extending outwardly from the primary sling strap, the secondary sling strap adjustably securing the base portion around the fetlock joint;
wherein the secondary sling strap perpendicularly crosses over the primary sling strap at a generally perpendicular angle when securing the base portion around the fetlock joint; and
wherein the primary sling strap extends at a selected downward angle from the base portion.

2. (canceled)

3. The equine support boot of claim 1, wherein at least one of the at least one upper strap is constructed from elastic hook-loop fabric.

4. The equine support boot of claim 1, wherein the primary sling strap comprises:
a primary tab portion;
a primary connector constructed from hook-loop fabric, the primary connector being releasably couplable to the exterior hook-loop fabric layer; and
a receiver constructed from hook-loop fabric.

5. The equine support boot of claim 4, wherein the primary sling strap further comprises:
a primary interior connector disposed on an interior surface of the primary tab portion, the primary interior connector being constructed from hook-loop fabric, such that the primary interior connector is releasable couplable to the exterior hook-loop fabric layer.

6. The equine support boot of claim 4, wherein the primary connector is constructed from elastic hook-loop fabric.

7. The equine support boot of claim 4, wherein the primary connector is connected to the primary tab portion using stitching.

8. The equine support boot of claim 4, wherein the primary connector and the primary tab portion are formed from the same section of material.

9. The equine support boot of claim 4, wherein the secondary sling strap comprises:
a secondary tab portion; and
a secondary connector constructed from hook-loop fabric, the secondary connector being releasably couplable to the receiver.

10. The equine support boot of claim 9, wherein the secondary sling strap further comprises:
a secondary interior connector disposed on an interior surface of the secondary tab portion, the secondary interior connector being constructed from hook-loop fabric, such that the secondary interior connector is releasable couplable to the exterior hook-loop fabric layer.

11. The equine support boot of claim 9, wherein the secondary connector is constructed from elastic hook-loop fabric.

12. The equine support boot of claim 9, wherein the secondary connector is connected to the secondary tab portion using stitching.

13. The equine support boot of claim 9, wherein the secondary connector and the secondary tab portion are formed from the same section of material.

14. The equine support boot of claim 1, wherein an exterior surface of the concave portion is at least one of coated, treated, and overlaid with a material to prevent damage to the base portion.

15. An equine support boot for supporting a fetlock joint of a horse, comprising:
a base portion, comprising:
at least one internal padded layer;
an exterior hook-loop fabric layer;
a concave portion selectively sized for receiving the fetlock joint; and
an arched bottom edge configured to form around the fetlock joint;
at least one upper strap extending outwardly from the base portion, the at least one upper strap being constructed from hook-loop fabric, such that the at least one upper strap is releasably couplable to the exterior hook-loop fabric layer;
a primary sling strap extending outwardly from the base portion, the primary sling. strap adjustably securing the base portion around the fetlock joint; and
a secondary sling strap extending outwardly from the primary sling strap, the secondary sling strap adjustably securing the base portion around the fetlock joint;
wherein the secondary sling strap perpendicularly crosses over the primary sling strap at a generally perpendicular angle when securing the base portion around the fetlock joint of the horse.

16. The equine support boot of claim 15, wherein the primary sling strap comprises:
a primary tab portion;
a primary connector constructed from hook-loop fabric, the primary connector being releasably couplable to the exterior hook-loop fabric layer; and
a receiver constructed from hook-loop fabric.

17. The equine support boot of claim 16, wherein the secondary sling strap comprises:
a secondary tab portion; and
a secondary connector constructed from hook-loop fabric, the secondary connector being releasably couplable to the receiver.

18. A method for providing support to a fetlock joint of a horse, comprising:
providing an equine support boot, comprising:
a base portion, comprising:
an exterior hook-loop fabric layer; and
a concave portion selectively sized for receiving the fetlock joint;
at least one upper strap extending outwardly from the base portion, the at least one upper strap being constructed from hook-loop fabric;
a primary sling strap extending outwardly from the base portion, the primary sling strap comprising:
a primary connector constructed from hook-loop fabric; and
a receiver constructed from hook-loop fabric; and
a secondary sling strap extending outwardly from the primary sling strap, the secondary sling strap comprising:
a secondary connector constructed from hook-loop fabric;
positioning the concave portion against the fetlock joint;
wrapping the base portion around the fetlock joint;
coupling the at least one upper strap to the exterior hook-loop fabric layer;
pulling the primary sling strap under the concave portion;
coupling the primary connector to the exterior hook-loop fabric layer;
tightening the secondary sling strap around the base portion;
coupling the secondary connector to the receiver; and
providing pressure to support the fetlock joint;
wherein the primary sling strap extends outwardly from the base portion at a selected downward angle.

19. (canceled)

20. The method of claim 18, wherein the at least one upper strap is constructed from elastic hook fabric.
